(19) United States
(12) Patent Application Publication
(10) Pub. No.: US 2016/0026937 A1
(43) Pub. Date: Jan. 28, 2016

(54) PORTABLE COMMUNICATION DEVICE AND SYSTEM AND METHOD THEREFOR

(71) Applicant: SITA INFORMATION NETWORKING COMPUTING IRELAND LIMITED, Letterkenny (IE)

(72) Inventor: Michael GORMLEY, Honolulu, HI (US)

(73) Assignee: SITA INFORMATION NETWORKING COMPUTING IRELAND LIMITED, Letterkenny (IE)

(21) Appl. No.: 14/775,186

(22) PCT Filed: Mar. 13, 2014
(86) PCT No.: PCT/EP2014/055037

§ 371 Date: Sep. 11, 2015

Related U.S. Application Data
(60) Provisional application No. 61/784,479, filed on Mar. 14, 2013.

(30) Foreign Application Priority Data
Oct. 4, 2013 (GB) 1317659.9

(51) Int. Cl. G06Q 10/02; H04L 29/08; G06F 3/0484; H04L 29/06; H04B 5/00; G06F 17/30

(52) U.S. Cl. CPC G06Q 10/02; H04B 5/0031; G06F 17/30905; G06F 3/04842; H04L 67/42; H04L 67/18

(57) ABSTRACT

A portable device for storing a token for providing a product or service to a user is disclosed. The device comprises a memory for storing one or more tokens, means for detecting a tag associated with the product or service and for receiving data from the tag. In response to detecting the tag, the device receives data from the tag, determines a provider code of the product or service based on the received data, determines a location code associated with a region in which the device is located; and identifies a token stored within the storage means based on the determined provider code and location code.

### FIELD OF THE INVENTION

This invention relates in general to a boarding system and to a system for display of a token such as a boarding pass on a mobile device. More particularly, this invention relates to a boarding system for passengers such as those boarding an aeroplane at an airport. Even more particularly, this invention relates to a portable device for retrieving a token from a storage means, as well as a remote server for storing a plurality of tokens for one or more users.

### BACKGROUND OF THE INVENTION

Electronic tickets for travel in general are becoming increasingly more commonplace. Further, a passenger may check-in on-line using a computer connected to the internet or using a mobile telephone connected to the internet. The electronic boarding pass is then sent to the user's device.

In order to display the passenger details of a boarding pass in an expedient manner, for example when a passenger needs to find their seat or when a flight attendant requests to see the boarding pass, the passenger must first activate the mobile telephone and manually search for the boarding pass, which may be time consuming.

### SUMMARY OF THE INVENTION

The invention is defined in the appended claims to which reference should now be made. Embodiments of the invention seek to address the above, and other problems, by providing an improved portable device for retrieving a token and an improved boarding system.

Embodiments of the invention provide a system and method by which a current or correct boarding pass, such as an NFC boarding pass, may be displayed on a user's mobile communication device by placing the device in close proximity to an NFC sticker placed at strategic points on an aeroplane or other transportation means.

The current or correct boarding pass may be determined based on current local time, location, or/and by determining which boarding pass has previously been scanned or entered into a computer system at an airport departure gate.

Embodiments of the invention advantageously use a short-range wireless protocol, such as a wireless radio protocol, to communicate information from a tag to the use's mobile device. Usually, communication occurs only when the device is placed in close proximity to the tag, for example, within about 10 cm of the tag.

In response to detecting the NFC sticker or tag, the mobile device may launch a mobile boarding pass application which reads an airline code encoded on or within the NFC sticker. Thus, a reader for reading data from the tag may be provided.

According to one aspect of the present invention, there is provided a method preferably performed by a processor for retrieving a transportation boarding pass from a storage device, comprising the steps of: receiving from a tag a code configured to launch a mobile boarding pass application; determining from encoded data received from the tag, a code uniquely identifying a provider of the transportation service; deriving a transportation hub code of a region where the device is currently located; and using the determined transportation hub code and transportation provider code to select a boarding pass stored on the storage device and preferably to select one boarding pass from a plurality of boarding passes stored on the storage device associated with the device.

According to a further aspect of the present invention, there is provided a portable communication device for storing a token for providing a product or service to a user, the device comprising: storage means for storing one or more tokens; means for detecting a tag associated with the product or service and for receiving data from the tag, wherein in response to detecting the tag, the device: receives data from the tag; determines a provider code of the product or service based on the received data; determines a location code associated with a region in which the device is located; and identifies a token stored within the storage means based on the determined provider code and location code.

According to a further aspect of the present invention, there is provided a portable communication device for retrieving a token for providing a product or service to a user, the device comprising: means for detecting a tag associated with the product or service; receiving means for receiving data from the tag in response to the device detecting the tag; and processing means for determining a provider code of the product or service based on the received data and for determining a location code associated with a region in which the device is located; and means for retrieving a token associated with the determined provider code and location code.

According to yet a further aspect of the present invention, there is provided a server for retrieving a token for providing a product or service to a user, the server comprising: receiving means for receiving data from a portable communication device in response to the device detecting a tag; wherein the data comprises a provider code of the product or service and a location code associated with a region in which the device is located; and means for retrieving a token associated with the determined provider code and location code.

An application may derive the current date and the airport location code associated with the airport where the device is currently located and retrieves a boarding pass from the passenger's mobile device encoded with one or more of an airline code, an airport code, and date which match the data derived by the mobile device. The airport code may be derived using a location based service to determine the position of the mobile device. Preferably, a database for determining the location code is used, and based on the location data, the airport location code is determined. In one example, the portable communication device may be a mobile telephone, laptop computer or other portable communication device such as a tablet computing device.

Usually, the storage means or memory is a solid state storage means such as an integrated circuit chip or removable memory card. In one example, the token may be stored on a subscriber identity module, SIM, associated with a user's communication device. However, remote storage, such as a server remote from the user's mobile communication device may be provided which may store a plurality of tokens.

One advantage of using this method to retrieve and display the active boarding pass is that the passenger does not have to search and activate the corresponding application on the mobile telephone to display the boarding pass details. Further, if a number of boarding passes are stored on the device, embodiments of the invention may distinguish between a number of boarding passes and select one of the boarding passes based on a number of criteria.

Although preferably, display of a token on the user's communication device is preferably, this step is optional. Additionally, staff, such as ground staff or flight attendants may be provided with a reader to read relevant information from the user's device and communicate it to the staff, for example using visual, audio, tactile or other communication means.

### BRIEF DESCRIPTION OF THE DRAWINGS

An embodiment of the invention will now be described, by way of example only, and with reference to the accompanying drawings, in which:

FIG. 1 is a schematic diagram of the main functional components of a system embodying the invention;

FIG. 2 is a flow diagram showing the main steps performed by an embodiment of the invention; and

FIG. 3 is a schematic diagram showing the boarding pass displayed on a user's mobile device after it is placed in close proximity to a Near Field Communication, NFC, sticker.

The following description is of a system for use in the aviation industry, but this is exemplary and other applications of the invention will also be discussed. For example, the system may be used in any environment where a product or service is issued to a user provided a user is in possession of a valid token for that product or service. Thus, embodiments of the invention have particular application in the travel industry, for example rail, air, coach and the like, but also in the ticketing industry, such as ticketing for theatre, cinema and the like. Further, embodiments of the invention may advantageously applied to other industry sectors for example displaying the correct football game ticket from a number of football game tickets stored on the mobile device based on a provider code and a location code.

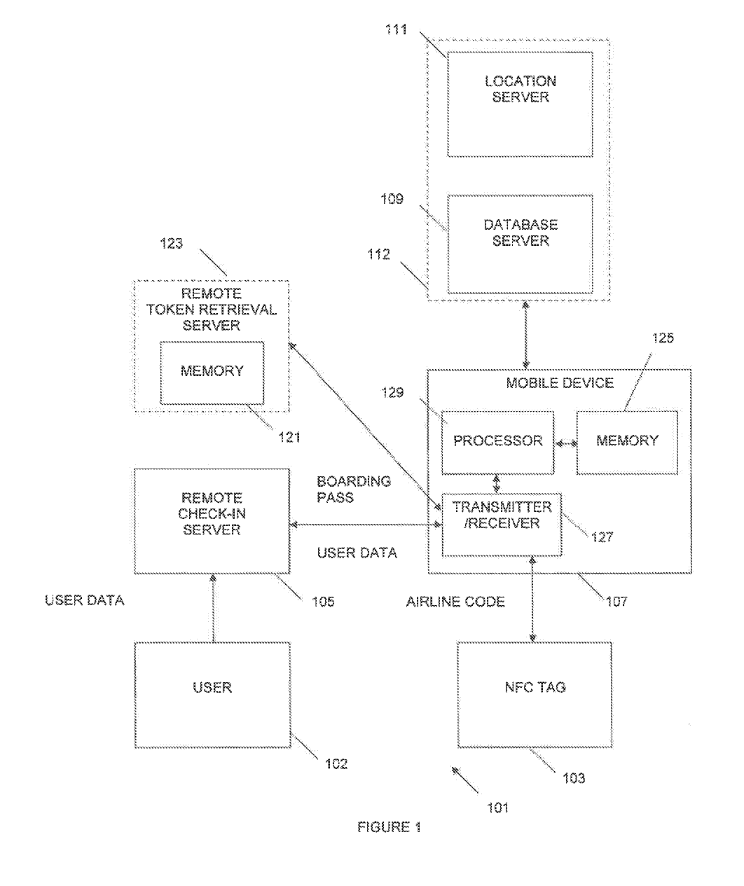

FIG. 1 of the accompanying drawings shows the main functional components of a system 101 embodying the invention. The components shown within the dashed line 112 of FIG. 1 may be located at an airport, although the database server 109, and location server 111 do not necessarily need to be located at an airport. The system may comprise one or more of a remote check-in server 105 provided by an airline or third party, a mobile device, 107, location server 111, database server 109, remote check-in server 105, and a tag.

The remote check-in server 105 may be configured to allow a passenger to check-in to a flight for which the passenger has purchased a ticket to travel. In general, each server is communicatively coupled to the mobile device, usually via a communications network.

Typically, the passenger 102 remotely accesses the server 105 via a computer or a mobile communication device 107 such as a portable laptop or mobile telephone. However, the user may perform check-in in person at the airport using a check-in desk.

The mobile communication device may include a computing device, such as a desktop computer, a laptop computer, a tablet computer, a personal digital assistant, a mobile telephone, a smartphone, an internet enabled television, an internet enabled television receiver, an internet enabled games console or portable games device.

It will be appreciated that each server may comprise a computer processor running one or more server processes for communicating with the mobile devices. The server processes comprise computer readable program instructions for carrying out the operations of the present invention. The computer readable program instructions may be or source code or object code written in or in any combination of suitable programming languages including procedural programming languages such as C, object orientated programming languages such as C#, C++, Java, scripting languages, assembly languages, machine code instructions, instruction-set-architecture (ISA) instructions, and state-setting data.

The communications network may be any public, private, wired or wireless network. The communications network may include one or more of a local area network (LAN), a wide area network (WAN), the Internet, a mobile telephony communication system, or a satellite communication system. The communications network may comprise any suitable infrastructure, including copper cables, optical cables or fibres, routers, firewalls, switches, gateway computers and edge servers.

Regardless of how the user performs check-in, associated with each user is a token storage medium such as a mobile or portable communication device 107, such as portable telephone, which is capable of storing, in a memory 125, a boarding pass such as an electronic boarding pass or e-boarding pass. The token storage medium may be a remote token storage medium such as a remote memory 121 which is accessible, using known wireless and wired protocols which will be known to the skilled person, via a remote token retrieval server 123.

The boarding pass may be thought of as a token which is issued by a service provider to a user which allows the user receive the product or service in return for payment. Usually, the boarding pass is stored on a Subscriber Identity Module, SIM, associated with the mobile device, but the boarding pass may alternatively be stored on another memory chip or on a removable memory card associated with the mobile device.

The storage medium may be capable of storing a plurality of tokens in a manner which facilitates retrieval of one token from the plurality of tokens.

Usually, the servers 105, 123, and 112 are wirelessly coupled to the user's mobile device 107, for example, using a wireless communications network, but in principle, any communications means, such as a wired network may be used provided the e-boarding pass can be transferred to, and stored on the user's mobile device 107.

Usually, the mobile device 107 comprises a Near Field Communication (NFC) chip communicatively couple to the mobile device. Typically, the NFC enabled integrated circuit or chip is hard wired to the mobile device, but this is in fact optional. However, the mobile device comprises a communication means which allows a boarding pass application stored on the mobile device 107 to be automatically activated in response to the mobile device 107 being placed in close proximity to an activation device, which is usually an NFC sticker encoded with a unique mime type and preferably also encoded with a unique airline code of the operating airline. The mobile device usually comprises a processor 129 for performing various functions which will be explained in further detail below. The device may further comprise a transmitter/receiver 127 to wirelessly communicate with the NFC sticker or tag, and also to communicate with servers 123 and 125 and 112. It will be appreciated that a single server may be provided to perform the functions of servers 112, 123, and 105.

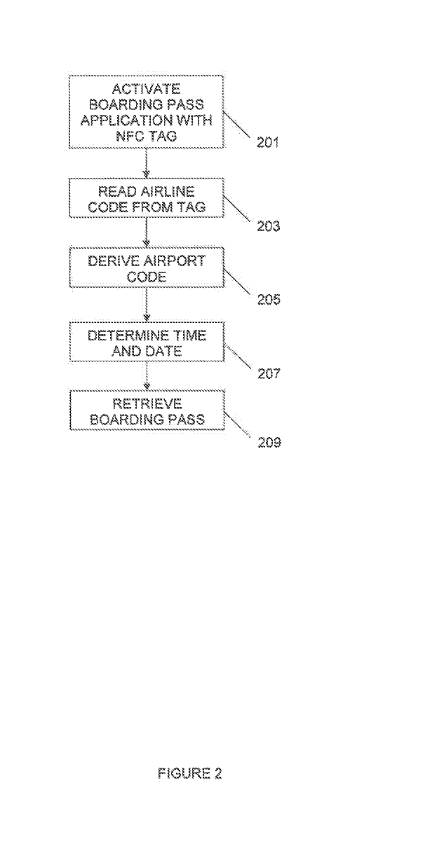

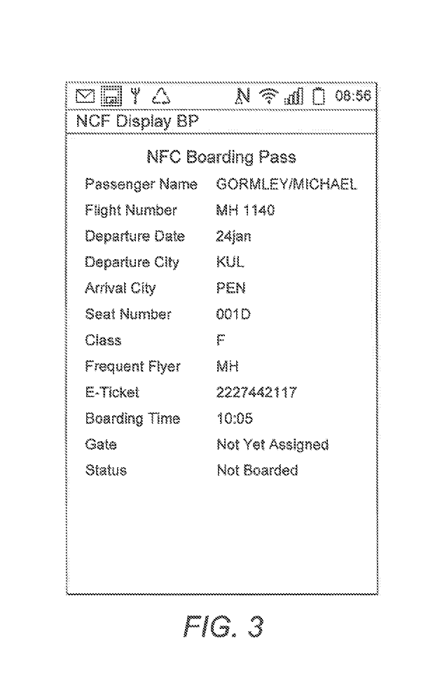

Operation of the boarding system 101 will now be described referring to FIGS. 2 and 3 of the drawings. In order to check-in, the passenger usually enters their name and optionally a mobile telephone number and email address associated with the passenger. The passenger may perform this step at a remote location from the airport 203. Once the passenger has checked-in, the remote check-in server then sends, usually wirelessly, the boarding pass to the mobile device. The remote check-in server may alternatively or in addition send the boarding pass to a remote token retrieval server 123 which may include a memory for storing one or more boarding passes. This may be via a local ad-hoc network established between the check in server 105 and the mobile device 107/remote token retrieval server 123. This may be the case if the passenger is checking-in in person at the airport. In this case, the boarding pass may be transferred from the check in server or check in desk coupled to the check in server to the mobile device using a local wireless network. The boarding pass may also be transferred to the mobile device in response to the user placing the mobile device in close proximity to a NFC device coupled to the check in desk or/and the remote check in server. This may be beneficial if the user is unable to complete check-in prior to arrival at the airport, or if the user was unable to receive the electronic boarding pass from the remote server.

The mobile device 107 may store the boarding pass in memory or using other storage means, but this is optional.

Prior to a flight taking place, a low-cost NFC sticker or NFC tag is placed at strategic points on the aeroplane, for example, at the entry or/and at the emergency exits of the aeroplane. Alternatively or in addition to placing one or more stickers at entry/exit points, one or more NFC stickers may also be placed within the aircraft so that a sticker is in close proximity to a passenger's seat. Each sticker may be encoded with a unique mime type and the airline code of the operating airline. Alternatively, a small battery powered transmitter/receiver, such as an iBeacon, which may use low-power wireless Bluetooth communication protocols, may be used alternatively or in addition to the NFC sticker. The wireless transmitter/receiver may comprise storage means for storing data for launching a mobile application and for storing the airline code of the operating airline.

When the mobile device is placed in close proximity to the sticker or iBeacon, the following steps, shown in FIG. 2 of the drawings, may take place. For clarity, the following description will focus on placing a device in close proximity to a sticker.

It will be appreciated that the flow chart of FIG. 2 illustrates the operation of an example implementation of systems, methods, and computer program products according to various embodiments of the present invention. Each block in the flowchart or block diagrams may represent a module comprising one or more executable computer instructions, or a portion of an instruction, for implementing the logical function specified in the block. The order of blocks in the diagram is only intended to be illustrative of an example. In alternative implementations, the logical functions illustrated in particular blocks may occur out of the order noted in the figures. For example, two blocks shown as adjacent one another may be carried out simultaneously or, depending on the functionality, in the reverse order. Each block in the flowchart may be implemented in software, hardware or a combination of software and hardware.

At step 201, the boarding pass application is automatically activated on the mobile telephone using the mime type encoded on the sticker. The mime type may comprise information indicative of or associated with one or more boarding passes stored on the mobile telephone.

The mobile device uses the unique mime type to launch the mobile boarding pass application. Usually, the NFC sticker tag has the airline code of the operating airline internally stored on it. If this is the case, then once the boarding pass application is activated, the mobile device detects the airline code.

The mobile device may detect the mime type and the airline code at substantially the same time in response to the mobile device being placed in close proximity to the NFC sticker.

At step 203, the boarding pass application reads the airline code from the sticker. At step 205, the application derives the airport code of where the mobile telephone is currently located. This may be achieved by using the latitude and longitude to lookup a database of airport codes. Usually, one airport code is associated with a particular geographical region, such as London Heathrow airport, LHR.

At step 207, the current date and time are determined. The mobile device may determine the current date and time based on the current date and time store on the mobile device, if for example, the user has switched off wireless communications of the mobile device.

Alternatively, the mobile device may determine the current data and time using a wired or wireless connection to connect to a network to determine the current date and time.

At step 209, the mobile application then uses one or more of the airline code, airport code, and the current date and preferably time to retrieve an NFC boarding pass stored on the mobile telephone. Usually, the mobile application is configured to retrieve the current boarding pass. A boarding pass to be retrieved may be identified based on the airline code, airport code, and the current date and preferably time. Usually, a boarding pass to be retrieved is identified if one or more of the airline code and airport code and current date and time determined by the mobile telephone corresponds to, or matches corresponding data associated with one of the stored boarding passes or tokens. Depending upon the particular data being compared, exact correspondence between the data stored in the boarding pass or token, and the data determined by the mobile device may not be necessary. For example, in the case of a comparison of temporal information, the scheduled departure time and the current time may be determined to correspond if the data is within a few hours or minutes of each other. Some embodiments of the invention may require that the temporal information is determined to match if, for example the data matches, for example if the current date determined by the portable communication device is 14 Mar. 2013 and the date encoded on or within the boarding pass or token is also 14 Mar. 2013, then the device may determine a match between the two data fields. Accordingly, the device may identify a particular boarding pass or token and also retrieve a particular boarding pass or token using this or other data.

The mobile boarding pass details may then be displayed. As shown in FIG. 3, usually one or more of the following information is displayed on the NFC boarding pass: Passenger name, flight number, departure date, departure city, arrival city, sear number, class, frequent flyer, e-ticket number boarding time, gate, and status.

Embodiments of the invention are particularly advantageous when, for example, a business traveller has a number of boarding passes stored on their mobile device. Based on the airport code/location information and date information, the mobile application may distinguish between a number of stored boarding passes and select one of the boarding passes for display. In addition, the mobile device boarding pass application may distinguish between the boarding passes based on an airline code read from an NFC sticker positioned close to the departure gate at the airport and the system time stored on the mobile device. This may be useful in the event that mobile device is unable to access wireless network services since the correct mobile boarding pass may be displayed without connecting to networked services.

In light of the foregoing, it will be appreciated that any communication protocol may be used to provide communications between the tag and mobile device, such as NFC, Bluetooth, Bluetooth low energy, or remote notifications from a mobile application.

Further, it will be also appreciated that it is not essential to store the token locally on the mobile device, for example in the SIM or other storage means. For example, the tokens may be remotely stored on a memory 121 which may be part of a server which stores one or more tokens, which is accessible via any one of a number of wireless or wired communication protocols. For example, Cloud-based storage may be used. Further, it will also be appreciated that the steps which have been described as being performed by a mobile communication device may also be performed by a remote server to determine which of a plurality of boarding passes should be retrieved from a storage means, based on data such as a provider code which is received from the mobile device, and a location code associated with a region in which the device is located.

Embodiments of the invention may include an on-screen graphical user interface. The user interface may be provided, for example, in the form of a widget embedded in a web site, as an application for a device, or on a dedicated landing web page. Computer readable program instructions for implementing the graphical user interface may be downloaded to the client device from a computer readable storage medium via a network, for example, the Internet, a local area network (LAN), a wide area network (WAN) and/or a wireless network. The instructions may be stored in a computer readable storage medium within the client device.

As will be appreciated by one of skill in the art, the invention described herein may be embodied in whole or in part as a method, a data processing system, or a computer program product including computer readable instructions. Accordingly, the invention may take the form of an entirely hardware embodiment or an embodiment combining software, hardware and any other suitable approach or apparatus.

The computer readable program instructions may be stored on a non-transitory, tangible computer readable medium. The computer readable storage medium may include one or more of an electronic storage device, a magnetic storage device, an optical storage device, an electromagnetic storage device, a semiconductor storage device, a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk.

Exemplary embodiments of the invention may be implemented as circuit board which may include a CPU, a bus, RAM, flash memory, one or more ports for operation of connected I/O apparatus such as printers, display, keypads, sensors and cameras, ROM, a communications sub-system such as a modem, and communications media.

1. A portable communication device for retrieving a token for providing a product or service to a user, the portable communication device comprising:
means for detecting a tag associated with the product or service;
receiving means for receiving data from the tag in response to the portable communication device detecting the tag;
processing means for determining a provider code of the product or service based on the received data and for determining a location code associated with a region in which the portable communication device is located; and
means for retrieving a token associated with the determined provider code and location code.

2. A portable communication device according to claim 1 further comprising a display means for displaying the token associated with the determined provider code and location code; transmission means for sending the retrieved token to a reader; and a storage means configured to store a plurality of tokens.

3-4. (canceled)

5. A portable communication device according to claim 1 wherein the processing means is further configured to identify a token stored on a storage means associated with the portable communication device and preferably wherein the processing means is further configured to identify the token stored on the or a storage means based on the determined provider code and location code.

6. (canceled)

7. A portable communication device according to claim 1 wherein the processing means is further configured to:
a. identify a plurality of tokens associated with the determined provider and location code;
b. determine the current temporal information associated with the portable communication device; and
c. uniquely identify a single token from the plurality of tokens based on a comparison of the determined current temporal information and temporal information encoded within the plurality of tokens.

8. A portable communication device according to claim 1 further comprising communication means for sending a request, to a remote server, for a token associated with the determined provider and location code and preferably wherein the request further comprises a user identifier.

9. A portable communication device according to claim 1 in which the processing means is further configured to determine the time at which the tag is detected, and preferably in which the identification of the token is further based on the time when the tag is detected.

10-11. (canceled)

12. A portable communication device according to claim 1 wherein the processing means is further configured to retrieve the token from the or a storage means using the determined location code and provider code and preferably to launch a mobile boarding pass application in response to detecting the tag and further preferably to display the retrieved token on a display.

13. (canceled)

14. A portable communication device according to claim 1 further comprising means for receiving location data defining the location of the portable communication device in response to detecting the tag, wherein the processing means is further configured to use the received location data to search a database of airport codes associated with the location data.

15. (canceled)

16. A portable communication device according to claim 2 wherein the plurality of tokens is a plurality of boarding passes and wherein each boarding pass comprises data associated with a flight number, departure city and a scheduled boarding time.

17. A portable communication device according to claim 16 wherein the processing means is further configured to compare the determined provider code and location code with corresponding boarding pass data stored in the storage means^{.} and preferably further configured to compare the scheduled boarding time with a time determined by the portable communication device, and to distinguish between the plurality of tokens based on the provider code, location code and the current date and time where the portable communication device is located.

18-21. (canceled)

22. A portable communication device according to claim 1 further comprising a near field communication, NFC, integrated circuit chip encoded with a mime type code for launching a mobile boarding pass application on the portable communication device and preferably wherein the NFC chip is configured to communicate with the detected tag.

23. A method for retrieving a token for providing a product or service to a user, the method comprising:
detecting a tag associated with the product or service;
receiving data from the tag in response to the portable communication device detecting the tag;
determining, preferably using processing means, a provider code of the product or service based on the received data;
determining, preferably using processing means, a location code associated with a region in which the portable communication device is located; and
retrieving a token associated with the determined provider code and location code.

24. A method according to claim 23 wherein the portable communication device identifies the token based on a date determined by the portable communication device.

25. (canceled)

26. A method according to claim 23 further comprising the step of determining the time at which the tag is detected, and preferably in which the identification of the token is further based on the time when the tag is detected.

27. (canceled)

28. A method according to claim 23 further comprising the step of determining the provider code of the product or service from data encoded on or within the tag.

29. A method according to claim 23 further comprising the step of retrieving the token from a storage means using the determined location code and provider code and preferably displaying the retrieved token on a display.

30. (canceled)

31. A method according to claim 23 further comprising the step of receiving location data defining the location of the portable communication device in response to detecting the tag and using the received location data to search a database of airport location codes associated with the location data.

32. (canceled)

33. (canceled)

34. (canceled)

35. A method according to claim 23 further comprising the step comparing the determined provider code and location code with corresponding data stored in a storage means; and preferably comparing the scheduled boarding time with a time determined by the portable communication device and distinguishing between the plurality of tokens based on the provider code, location code and the current date and time where the portable communication device is located.

36-39. (canceled)

40. A method according to claim 23 further comprising a near field communication, NFC, integrated circuit chip encoded with a mime type code for launching a mobile boarding pass application on the portable communication device.

41-42. (canceled)

43. A non-transitory computer program product comprising instructions which when executed, undertake the method of claim 23.
